(19) United States
(12) Patent Application Publication
(10) Pub. No.: US 2024/0077162 A1
(43) Pub. Date: Mar. 7, 2024

(54) HEATING ANTI-FREEZING HOSE WITH HEAT TRACING BAND FIXED BY EXTRUSION MOLDING

(71) Applicant: Hangzhou Lunle Technology Co., Ltd., Hangzhou (CN)

(72) Inventors: Xiasheng FU, Hangzhou (CN); Qingsheng LIU, Hangzhou (CN); Shengfu LI, Hangzhou (CN)

(21) Appl. No.: 17/958,197

(22) Filed: Sep. 30, 2022

(30) Foreign Application Priority Data
Sep. 2, 2022 (CN) 202211072721.4
Sep. 2, 2022 (CN) 202222336872.8

(51) Int. Cl. F16L 53/38; F16L 59/153

(52) U.S. Cl. CPC F16L 53/38; F16L 59/153

(57) ABSTRACT

A heating anti-freezing hose with a heat tracing band fixed by extrusion molding comprises a heating hose body. The heating hose body comprises the heat tracing band, an inner water supply pipe, and a heating and fixing layer. One side of the heat tracing band is attached to an outer side of an anti-explosion reinforced layer. The heating and fixing layer is wrapped on an outer side of the heat tracing band and the anti-explosion reinforced layer by pipe fitting extrusion molding. According to the heating anti-freezing hose, the heating and fixing layer is formed on an outer side of the inner water supply pipe and the heat tracing band through a water pipe extruder, so that the inner water supply pipe is tightly combined with the heat tracing band. The heating and fixing layer has multiple functions of all-round protection of the heat tracing band.

### CROSS-REFERENCE TO RELATED APPLICATIONS

This application claims foreign priority of Chinese Patent Application No. 202211072721.4 with a filing date of Sep. 2, 2022, Chinese Patent Application No. 202222336872.8 with a filing date of Sep. 2, 2022 in the China National Intellectual Property Administration, the disclosures of all of which are hereby incorporated by reference.

### TECHNICAL FIELD

The present invention belongs to the field of water pipe anti-freezing technologies, and particularly to a heating anti-freezing hose with a heat tracing band fixed by extrusion molding in which a water pipe body is tightly combined with the heat tracing band by forming a heating and fixing layer through extrusion molding.

### BACKGROUND

Outdoor equipment or places such as a recreational vehicle, a yacht and a livestock house need irregular water supplementation from a water source. The water supplementation is mostly realized by water pipe transportation. However, when outdoor weather is lower than 0° C., a water body in a hose may freeze, so that the water supplementation cannot be performed, leading to a situation that the recreational vehicle and the yacht cannot get usable domestic water in time in cold weather. At the moment, an anti-freezing hose with a heating function needs to be used to ensure that the water body cannot freeze during transportation.

An existing heating hose mainly comprises the following three structures. In a first structure, a heat tracing band for heating is arranged inside a water pipe; the heat tracing band in this structure can reduce a through-flow cross section of the water pipe and reduce a water transportation efficiency of the hose; and in addition, the heat tracing band arranged inside the water pipe is directly contacted with the water body, so that a surface material of the heat tracing band needs to be ensured to be nontoxic and harmless, which will increase a cost of the hose.

In a second structure, the heat tracing band is adhered to an outer side of the water pipe, and a glue needs to be coated between the heat tracing band and the water pipe in this structure for adhesion, so that a production efficiency is low; moreover, the glue between the heat tracing band and the water pipe can reduce a heat transfer efficiency; in addition, most glues remaining flexible after solidification have a poor heat stability, while a joint between the heat tracing band and the water pipe is a portion with a highest temperature on the water pipe; and the heat tracing band of the heating hose of this structure is easy to fall off after long-term use.

In a third structure, the heat tracing band is fixed on an outer side of the water pipe by tools such as an adhesive tape, a binding tape or a hoop, and it is difficult to ensure that all positions of the heat tracing band are closely attached to the water pipe, thus affecting the heat transfer efficiency. In addition, the adhesive tape, the binding tape or the hoop applies an extrusion force on a local position of the heat tracing band, which is easy to cause damage to the heat tracing band.

In addition, the patent application with the application number “201721776861.4” provides a fire-fighting water pipe with electric tracing band; a plurality of heat tracing bands are adhered to the water pipe through adhesive tapes; a flame-retardant layer coating band, a heat insulation layer, a moisture-proof layer and a protective layer are arranged on an outer side of the heat tracing band in a spiral winding or sheathing mode; the fire-fighting water pipe has a problem of cumbersome preparation process (multiple spiral winding and sheathing operations need to be performed); and a certain gap between an inner layer and an outer layer is required in the sheathing operation, leading to insufficient connection between different layers of the water pipe.

### SUMMARY

The present invention aims to provide a heating anti-freezing hose with a heat tracing band fixed by extrusion molding.

A heating anti-freezing hose with a heat tracing band fixed by extrusion molding comprises a heating hose body. The heating hose body comprises the heat tracing band, an inner water supply pipe, and a heating and fixing layer. One side of the heat tracing band is attached to an outer side of an anti-explosion reinforced layer. The heating and fixing layer is wrapped on an outer side of the heat tracing band and the anti-explosion reinforced layer by pipe fitting extrusion molding.

Preferably, the inner water supply pipe comprises a water-passing layer, a fiber mesh layer and the anti-explosion reinforced layer which are sequentially laminated from inside to outside. The water-passing layer, the fiber mesh layer and the anti-explosion reinforced layer are all in a circular tube shape.

Preferably, the anti-explosion reinforced layer and the heating and fixing layer are made of the same material and integrated into a whole after extrusion molding.

Preferably, the heat tracing band comprises an electric core, and a sleeve layer, a shielding mesh, an insulating layer and a conductive heating core which are sequentially wrapped from outside to inside. Two electric cores arranged at an interval are both buried inside the conductive heating core.

Preferably, two ends of the heating hose body are both provided with a hose connector. A joint between the hose connector and the heating hose body is wrapped with a connector sleeve.

Preferably, one end of the heat tracing band extends out of a corresponding end of the heating hose body, or two ends of the heat tracing band both extend out of two ends of the heating hose body. A part of the heat tracing band extending out of the heating hose body is wound on a water supply connector of a water source or a water receiving end in use.

Preferably, the heating anti-freezing hose with the heat tracing band fixed by extrusion molding further comprises a heat insulation sleeve. The heat insulation sleeve is capable of wrapping the water supply connector of the water source or the water receiving end. The water supply connector of the water source and/or the water receiving end wound with the heat tracing band is wrapped by the heat insulation sleeve in use. A length of an end portion of the heat tracing band extending out of an end portion of the heating hose body is 20 cm to 50 cm.

Preferably, the heating anti-freezing hose with the heat tracing band fixed by extrusion molding further comprises a temperature control switch and a power supply plug. One end of a power supply interface of the heat tracing band is connected with the power supply plug through the temperature control switch. The temperature control switch is used for controlling powering on and off of the heat tracing band according to an environment temperature; and when the temperature is lower than a threshold, the temperature control switch is turned on.

Preferably, the temperature control switch comprises a shell, a wiring terminal, a hot bimetallic strip, an actuating rod, a first contact piece and a second contact piece. The first contact piece is mounted in a central position in the shell; and the actuating rod is slidably connected in the shell. The hot bimetallic strip is mounted in the shell. The hot bimetallic strip, the actuating rod and the first contact piece are sequentially arranged along a sliding direction of the actuating rod. An end portion of the actuating rod oriented to the first contact piece is fixed with the second contact piece. Edges of two ends of the hot bimetallic strip are clamped between an end cover and a limiting block inside the shell. A spring is mounted between the actuating rod and the shell; and the spring applies an elastic force to the actuating rod towards the hot bimetallic strip. Two wiring terminals are fixed on the shell. The first contact piece is electrically connected with one wiring terminal. The second contact piece is electrically connected with the other wiring terminal. When the temperature is greater than or equal to the threshold, the hot bimetallic strip protrudes towards one side far away from the first contact piece, and the second contact piece is separated from the first contact piece. When the temperature is less than the threshold, the hot bimetallic strip protrudes towards one side close to the first contact piece, and the second contact piece is contacted with the first contact piece.

Preferably, a preparation process of the heating anti-freezing hose with the heat tracing band fixed by extrusion molding comprises the following steps of:
step 1: producing the inner water supply pipe by a water pipe extruder; and
step 2: combining the inner water supply pipe with the heat tracing band by the water pipe extruder provided with a special-shaped mold, wherein an extrusion channel of the special-shaped mold comprises a circular portion and a flat portion which are communicated together; and the flat portion is arranged on one side of the circular portion; penetrating the inner water supply pipe produced in the step 1 through the circular portion of the extrusion channel of the special-shaped mold; penetrating the heat tracing band through the flat portion of the extrusion channel of the special-shaped mold; and melting raw material particles by the water pipe extruder and then transporting the raw material particles into the extrusion channel of the special-shaped mold, and solidifying the raw material particles in the extrusion channel to form the heating and fixing layer.

The present invention has the beneficial effects as follows.
1. In the present invention, the heating and fixing layer is formed on the outer side of the inner water supply pipe and the heat tracing band through the water pipe extruder, so that the inner water supply pipe is tightly combined with the heat tracing band. The heating and fixing layer has multiple functions of all-round protection of the heat tracing band, improvement of a heat preservation effect, promotion of a heat exchange efficiency between the inner water supply pipe and the heat tracing band, so that the heating anti-freezing hose with the heat tracing band fixed by extrusion molding provided by the present invention can ensure stable water-passing of a water pipe at −40° C. (i.e., −40° F.), and an operating power at −40° C. is only 40 W/m to 45 W/m (i.e., 12.2 W/ft to 13.7 W/ft).
2. In the present invention, the heating and fixing layer formed by extrusion molding may shrink because of being far away caused by thermal expansion and cold contraction during cooling after molding, and a uniform extrusion force is applied to the inner water supply pipe and the heat tracing band, so that the heat tracing band is bent and deformed, and more tightly attached to the outer side of the inner water supply pipe, thus increasing a contact area between the heat tracing band and the inner water supply pipe, and improving a heat exchange efficiency.
3. In the present invention, the end portion of the heat tracing band extends out of the end portion of the inner water supply pipe, and the heat tracing band can be wound on the water supply connector of the water source or the water receiving end in use, thus avoiding a water body in the water supply connector from freezing, and further ensuring a reliability of water supply.
4. In the present invention, powering on at a temperature lower than 8° C. (46.4° F.) is realized by utilizing a characteristic that a state of the bimetallic strip is changed with temperature through the temperature control switch, thus improving an energy utilization rate.

### BRIEF DESCRIPTION OF THE DRAWINGS

FIG. 1 is a schematic diagram of an overall structure of Embodiment 1 of the present invention;

FIG. 2 is a schematic diagram of a cross-section structure of a heating hose body in Embodiment 1 of the present invention;

FIG. 3 is a schematic diagram of an overall structure of Embodiment 2 of the present invention;

FIG. 4 is a schematic diagram of an internal structure of a temperature control switch in Embodiment 2 of the present invention;

FIG. 5 is a schematic diagram of a use state of Embodiment 4 of the present invention;

FIG. 6 is a schematic diagram of molding of a heating and fixing layer in Embodiment 5 of the present invention; and

FIG. 7 is a cross-section view of assembly of a special-shaped mold and a water pipe extruder in Embodiment 5 of the present invention.

### DETAILED DESCRIPTION

The present invention is further described hereinafter with reference to the drawings.

### Embodiment 1

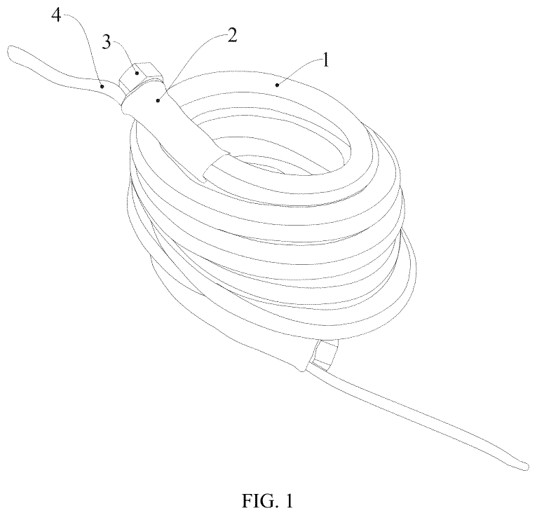

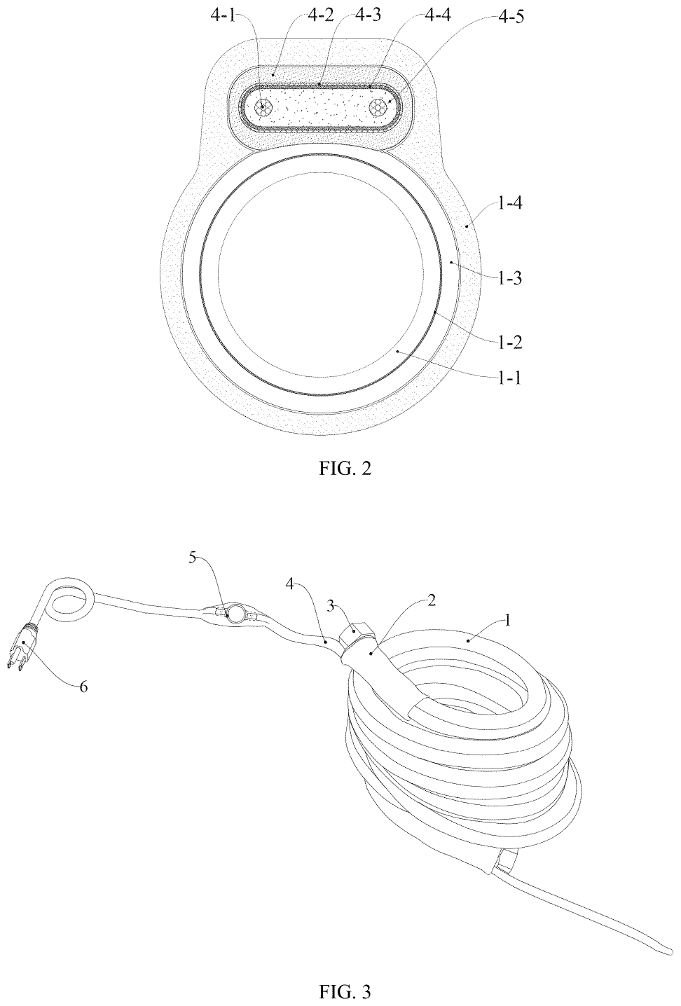

As shown in FIG. 1 and FIG. 2, a heating anti-freezing hose with a heat tracing band fixed by extrusion molding comprises a heating hose body 1, a connector sleeve 2 and a hose connector 3. The heating hose body 1 comprises the heat tracing band 4, an inner water supply pipe, and a heating and fixing layer 1-4. The inner water supply pipe comprises a water-passing layer 1-1, a fiber mesh layer 1-2 and an anti-explosion reinforced layer 1-3 which are sequentially laminated from inside to outside. The water-passing layer 1-1, the fiber mesh layer 1-2 and the anti-explosion reinforced layer 1-3 are all in a circular tube shape. One side of the heat tracing band 4 is attached to an outer side of the anti-explosion reinforced layer 1-3. The heating and fixing layer 1-4 is wrapped on an outer side of the heat tracing band 4 and the anti-explosion reinforced layer 1-3. The heat tracing band 4 is in a flat line shape (which means that a thickness of the heat tracing band 4 is less than a width).

The heating and fixing layer 1-4 applies an extrusion force on the heat tracing band 4 and the anti-explosion reinforced layer 1-3, so that a side surface of the heat tracing band 4 contacted with the anti-explosion reinforced layer 1-3 is in an arc shape, which increases a contact area between the heat tracing band 4 and the anti-explosion reinforced layer 1-3, thus improving a heating effect of the heat tracing band 4 on a water flow inside the heating hose body 1. The water-passing layer 1-1, the anti-explosion reinforced layer 1-3 and the heating and fixing layer 1-4 are all formed by extrusion molding, so that the present invention may realize production of the heating anti-freezing hose with the heat tracing band fixed by extrusion molding only via replacing different molds through one pipe fitting extruder, thus greatly reducing a complexity of a production process. The anti-explosion reinforced layer 1-3 and the heating and fixing layer 1-4 are made of the same material and integrated into a whole after extrusion molding. In the embodiment, the water-passing layer 1-1, the anti-explosion reinforced layer 1-3 and the heating and fixing layer 1-4 are preferably made of PVC. The fiber mesh layer 1-2 is preferably made of nylon.

The heat tracing band 4 comprises an electric core 4-1, and a sleeve layer 4-2, a shielding mesh 4-3, an insulating layer 4-4 and a conductive heating core 4-5 which are sequentially wrapped from outside to inside. Two electric cores 4-1 arranged at an interval are both buried inside the conductive heating core 4-5. A current is generated in the conductive heating core 4-5 to generate heat through a voltage between the two electric cores 4-1, so as to uniformly heat water bodies in different positions in the heating hose body 1.

When the heating hose body 1 is dragged on the ground, since the heating and fixing layer 1-4 is completely wrapped on a main portion of the heat tracing band 4, the heating and fixing layer 1-4 can effectively protect the heat tracing band 4 and avoid the heat tracing band 4 from being damaged by dragging on the ground. In addition, the heating and fixing layer 1-4 can play a role of heat preservation, thus improving a heat utilization efficiency.

Two ends of the heating hose body 1 are both provided with the hose connector 3. The hose connector 3 is a universal nut connector. A joint between the hose connector 3 and the heating hose body 1 is wrapped with the connector sleeve 2.

Two ends of the heat tracing band 4 respectively extend out of two ends of the heating hose body 1. Lengths of the two ends of the heat tracing band 4 extending out of the heating hose body 1 are both 35 cm. After the hose connector 3 is butted with a water supply connector of a water source or a water receiving end, a part of the heat tracing band 4 extending out of the heating hose body 1 is wound on the water supply connector. At the moment, the water supply connector of the water source or the water receiving end can also be heated, thus avoiding a problem of failed normal flowing of a water flow due to frozen water body inside the water supply connector.

An anti-explosion capability of the heating hose body 1 can be effectively improved while fixing the heat tracing band 4, increasing the contact area between the heat tracing band 4 and the anti-explosion reinforced layer 1-3, improving a heat exchange efficiency, and improving a heat insulation effect of a water pipe. In the embodiment, a thickness of the water-passing layer 1-1 is 1.1 mm; a thickness of the anti-explosion reinforced layer 1-3 is 0.8 mm; and a thickness of the heating and fixing layer 1-4 is 1.5 mm (except for the joint between the heat tracing band 4 and the inner water supply pipe). After the anti-explosion reinforced layer 1-3 is formed, the fiber mesh layer 1-2 is embedded in an inner side of the anti-explosion reinforced layer 1-3. At the moment, under a joint action of the water-passing layer 1-1, the fiber mesh layer 1-2, the anti-explosion reinforced layer 1-3, and the heating and fixing layer 1-4, the heating hose body 1 is capable of bearing a pressure of 3,000 kPa.

In order to prove an anti-freezing effect of the embodiment, an anti-freezing comparison experiment and a thawing comparison experiment were carried out. The two comparison experiments were both set with an experimental group and a control group. In the experimental group, a hose to be tested was the heating anti-freezing hose with the heat tracing band fixed by extrusion molding provided by the embodiment. In the control group, a hose to be tested was a heating hose spirally wound with an adhesive tape (that was, the heat tracing band 4 was attached to the outer side of the inner water supply pipe in the embodiment, and was spirally wound and fixed with the adhesive tape). The reason why the heating hose spirally wound with the adhesive tape was selected as the control group was that: a structure that the adhesive tape was completely wrapped on the inner water supply pipe on the outer side was obviously superior to adhering, binding and hooping structures. The heat tracing bands 4 in the hoses to be tested used in the experimental group and the control group were the same.

Experimental conditions of the anti-freezing comparison experiment were as follows: the hose to be tested which was filled with water was placed at −30° C. and −40° C. and powered on; and the water was supplied at a preset time node, and whether the hose to be tested could supply the water normally was observed. The experimental group and the control group were both set with three sets of identical hoses to be tested at the same temperature; and the three sets of hoses to be tested supplied water after 0.5 hour, 2 hours and 8 hours respectively except an initial moment. Experimental results of the experimental group were shown in Table 1; and experimental results of the control group were shown in Table 2.

TABLE 1
Table of results of anti-freezing comparison experiment of experimental group

| | | | | | Power | | | | Power |
|---|---|---|---|---|---|---|---|---|---|
| Environment | | Inlet | Outlet | | per | Inlet | Outlet | | per |
| temperature | | temperature | temperature | | meter | temperature | temperature | | meter |
| (° C.) | Moment 1 | (° C.) | (° C.) | Moment 2 | (W/m) | (° C.) | (° C.) | Moment 3 | (W/m) |
| −40 | 0 h | 27.1 | 27.2 | 0.5 h | 40.68 | 27.2 | 24.3 | 2 h | 38.75 |
| −30 | 0 h | 27.6 | 27.6 | 0.5 h | 38.55 | 28.3 | 27.6 | 2 h | 37.52 |

| | | | | Power | | |
|---|---|---|---|---|---|---|
| Environment | Inlet | Outlet | | per | Inlet | Outlet |
| temperature | temperature | temperature | | meter | temperature | temperature |
| (° C.) | (° C.) | (° C.) | Moment 4 | (W/m) | (° C.) | (° C.) |
| −40 | 27.2 | 22.5 | 8 h | 37.89 | 27.2 | 16.7 |
| −30 | 28.3 | 25.6 | 8 h | 36.88 | 28.3 | 24.8 |

TABLE 2
Table of results of anti-freezing comparison experiment of control group

| Environ- | | | | | | | | | |
|---|---|---|---|---|---|---|---|---|---|
| ment | | Inlet | Outlet | | Power | Inlet | Outlet | | Power |
| temper- | | temper- | temper- | | per | temper- | temper- | | per |
| ature | Mo- | ature | ature | Mo- | meter | ature | ature | Mo- | meter |
| (° C.) | ment 1 | (° C.) | (° C.) | ment 2 | (W/m) | (° C.) | (° C.) | ment 3 | (W/m) |
| −40 | 0 h | 27.1 | 27.2 | 0.5 h | 40.22 | 27.2 | 19.4 | 2 h | 39.02 |
| −30 | 0 h | 27.6 | 27.6 | 0.5 h | 39.32 | 28.3 | 25.9 | 2 h | 38.55 |

| Environ- | | | | | | |
|---|---|---|---|---|---|---|
| ment | Inlet | Outlet | | Power | Inlet | Outlet |
| temper- | temper- | temper- | | per | temper- | temper- |
| ature | ature | ature | Mo- | meter | ature | ature |
| (° C.) | (° C.) | (° C.) | ment 4 | (W/m) | (° C.) | (° C.) |
| −40 | 27.2 | 11 | 8 h | 39.46 | 27.2 | None |
| −30 | 28.3 | 19.6 | 8 h | 37.02 | 28.3 | 13.2 |

It can be seen from comparison between Table 1 and Table 2 that average power of the experimental group is very close to that of the control group, while water outlet temperatures of the experimental group at −30° C. and −40° C. at different moments are all obviously higher than corresponding water outlet temperatures of the control group. In addition, freezing occurs inside the heating hose spirally wound with the adhesive tape within 2 hours to 8 hours after the water supply is stopped in the case of continuously powering on at −40° C., so that the water supply cannot be continued. However, the heating anti-freezing hose with the heat tracing band fixed by extrusion molding provided by the embodiment can still supply water normally after the water supply is stopped for 8 hours. It is indicated that an anti-freezing performance of the heating anti-freezing hose with the heat tracing band fixed by extrusion molding provided by the embodiment is obviously better than that of the heating hose spirally wound with the adhesive tape.

Experimental conditions of the thawing comparison experiment were as follows: the hoses to be tested were subjected to a thawing test at −10° C., −20° C., −30° C. and −40° C. (ice inside the hoses was melted by powering on the heat tracing band 4); and before the experiment, the hoses to be tested were frozen at corresponding environment temperatures for 15 hours.

In the experimental group and the control group, power of the hoses to be tested reached stability within 30 minutes. Changes of power and temperatures of the heat tracing band within the first 30 minutes of the experimental group were shown in Table 3. Changes of power and temperatures of the heat tracing band within the first 30 minutes of the control group were shown in Table 4.

TABLE 3
Table of key parameters in thawing process of experimental group

| Environ- | | | | | Head | Tail | | | Head | Tail |
|---|---|---|---|---|---|---|---|---|---|---|
| ment | | Power | | Power | end | end | | Power | end | end |
| temper- | Mo- | per | Mo- | per | temper- | temper- | Mo- | per | temper- | temper- |
| ature | ment 1 | meter | ment 2 | meter | ature | ature | ment 3 | meter | ature | ature |
| (° C.) | (min) | (W/m) | (min) | (W/m) | (° C.) | (° C.) | (min) | (W/m) | (° C.) | (° C.) |
| −40 | 0 | 139.90 | 6 | 43.19 | 22 | 21 | 30 | 40.88 | 19 | 25 |
| −30 | 0 | 133.82 | 7 | 41.06 | 27 | 23 | 30 | 38.50 | 28 | 25 |
| −20 | 0 | 121.50 | 8 | 37.80 | 31 | 28 | 30 | 36.10 | 31 | 28 |
| −10 | 0 | 116.79 | 8 | 34.67 | 37 | 33 | 30 | 33.45 | 38 | 34 |

TABLE 4
Table of key parameters in thawing process of control group

| Environ- | | | | | Head | Tail | | | Head | Tail |
|---|---|---|---|---|---|---|---|---|---|---|
| ment | | Power | | Power | end | end | | Power | end | end |
| temper- | Mo- | per | Mo- | per | temper- | temper- | Mo- | per | temper- | temper- |
| ature | ment 1 | meter | ment 2 | meter | ature | ature | ment 3 | meter | ature | ature |
| (° C.) | (min) | (W/m) | (min) | (W/m) | (° C.) | (° C.) | (min) | (W/m) | (° C.) | (° C.) |
| −40 | 0 | 91.24 | 5 | 46.23 | 29 | 33 | 30 | 40.51 | 39 | 47 |
| −30 | 0 | 91.06 | 10 | 40.75 | 45.8 | 52.8 | 30 | 39.05 | 46.7 | 53.7 |
| −20 | 0 | 88.30 | 10 | 31.00 | 45 | 48 | 30 | 38.02 | 43 | 49 |
| −10 | 0 | 84.55 | 8 | 35.28 | 51 | 58 | 30 | 34.67 | 53 | 59 |

It can be seen from Table 3 and Table 4 that the changes of the power of the experimental group and the power of the control group in the first 30 minutes of the experiment are basically the same; and the power of the experimental group and the power of the control group are both kept at 40 W/m to 41 W/m at −40° C. after reaching stability. A surface temperature of the hoses to be tested in the experimental group is kept at 19° C. to 25° C. after reaching stability; and a surface temperature of the hoses to be tested in the control group is kept at 39° C. to 47° C. after reaching stability, which indicates that the control group has a greater heat loss than the experimental group.

The experimental group and the control group can both realize thawing and water supply within 1 hour at −10° C. and −20° C. The experimental group realizes thawing and water supply within about 1 hour at −30° C., and realizes thawing and water supply within about 1.5 hours at −40° C., which indicates that the heating anti-freezing hose with the heat tracing band fixed by extrusion molding provided by the embodiment can be used stably at −40° C. The control group realizes thawing and water supply within about 1.5 hours at −30° C., but fails to realize thawing and water supply within 2.5 hours at −40° C., which indicates that the hose in the control group can only be used stably at −30° C., but cannot be used stably at −40° C.

### Embodiment 2

As shown in FIG. 3, a heating anti-freezing hose with a heat tracing band fixed by extrusion molding further comprises a temperature control switch 5 and a power supply plug 6 in the embodiment based on Embodiment 1. One end of the electric core 4-1 in the heat tracing band 4 is connected with the power supply plug 6 through the temperature control switch 5. The power supply plug 6 is connected to a power supply. The power supply comprises but is not limited to a mains supply network and a storage battery. The temperature control switch 5 is used for controlling powering on and off of the heat tracing band 4 according to an environment temperature. When the temperature is lower than a threshold, the temperature control switch 5 is turned on, so that the heat tracing band 4 is powered on. The threshold in the embodiment is set to be 8° C. (46.4° F.).

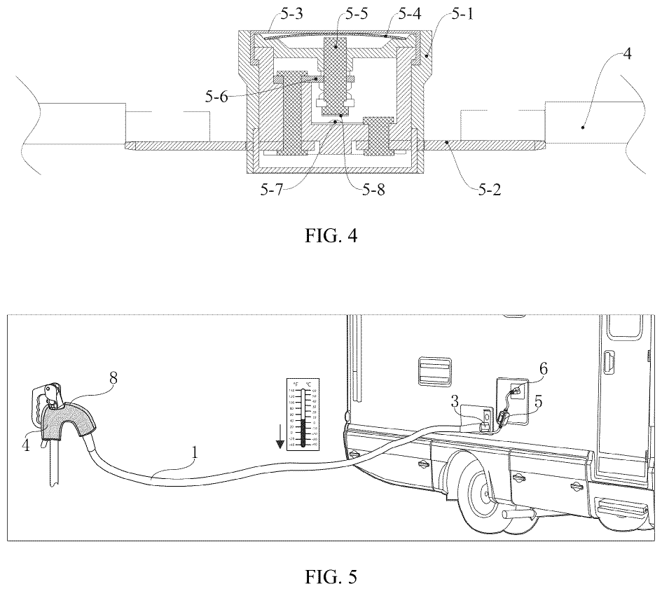

As shown in FIG. 4, the temperature control switch 5 comprises a shell 5-1, a wiring terminal 5-2, an end cover 5-3, a hot bimetallic strip 5-4, an actuating rod 5-5, a conductive piece 5-6, a first contact piece 5-7 and a second contact piece 5-8. The end cover 5-3 is fixed at an opening of the shell 5-1. The first contact piece 5-7 is mounted in a central position in the shell 5-1. The actuating rod 5-5 is slidably connected in the shell 5-1. The hot bimetallic strip 5-4 is mounted in the shell 5-1. The hot bimetallic strip 5-4, the actuating rod 5-5 and the first contact piece 5-7 are sequentially arranged along a sliding direction of the actuating rod 5-5. An end portion of the actuating rod 5-5 oriented to the first contact piece 5-7 is fixed with the second contact piece 5-8. Edges of two ends of the hot bimetallic strip 5-4 are clamped between the end cover 5-3 and a limiting block inside the shell 5-1. A spring is mounted between the actuating rod 5-5 and the shell 5-1. The spring applies an elastic force to the actuating rod 5-5 towards the hot bimetallic strip 5-4. The first contact piece 5-7 is electrically connected with one wiring terminal 5-2. The second contact piece 5-8 is electrically connected with the other wiring terminal 5-2 through the conductive piece 5-6.

When the temperature is greater than or equal to the threshold, the hot bimetallic strip 5-4 protrudes towards one side far away from the first contact piece 5-7. At the moment, the second contact piece 5-8 on the actuating rod 5-5 is separated from the first contact piece 5-7, so that the temperature control switch 5 is turned off. When the temperature is less than the threshold, the hot bimetallic strip 5-4 protrudes towards one side close to the first contact piece 5-7. At the moment, the actuating rod 5-5 moves towards the first contact piece 5-7 under a pushing force of the hot bimetallic strip 5-4, so that the second contact piece 5-8 is contacted with the first contact piece 5-7, and the temperature control switch 5 is turned on.

The temperature control switch 5 is connected in series between one electric core 4-1 of the heat tracing band 4 and one wiring terminal of the power supply plug 6. The other electric core 4-1 of the heat tracing band 4 is electrically connected with the other wiring terminal of the power supply plug 6 directly.

A use process of the heating anti-freezing hose with the heat tracing band fixed by extrusion molding is as follows.

Firstly, the hose connectors 3 at two ends of the heating hose body 1 are respectively butted with the water supply connectors of the water source and the water receiving end. The water receiving end comprises but is not limited to water tanks of a recreational vehicle and a yacht. Two ends of the heat tracing band 4 are respectively wound on outer sides of the water supply connectors of the water source and the water receiving end.

Then, the power supply plug 6 is plugged into the power supply. When the environment temperature of the temperature control switch 5 is lower than the threshold, two contacts in the temperature control switch 5 are automatically connected, and the heat tracing band 4 is powered on to heat, so that a temperature of water in a water pipe is increased to avoid freezing in the water pipe. The experiment shows that the heating anti-freezing hose with the heat tracing band fixed by extrusion molding can avoid a water flow in a water pipe body from freezing at the environment temperature of −40° C.

### Embodiment 3

A heating anti-freezing hose with a heat tracing band fixed by extrusion molding in the embodiment is different from that in Embodiment 1 or Embodiment 2 in that: two ends of the heat tracing band 4 do not extend out of the end portion of the heating hose body 1.

### Embodiment 4

As shown in FIG. 5, a heating anti-freezing hose with a heat tracing band fixed by extrusion molding further comprises an independent heat insulation sleeve 8 in the embodiment based on Embodiment 2. The heat insulation sleeve is capable of wrapping the water supply connector of the water source and/or the water receiving end.

The water supply connector of the water source and/or the water receiving end wound with the heat tracing band 4 is wrapped by the heat insulation sleeve 8 in use, thus further improving heat insulation and heating effects on the water supply connector. The water supply connector of the water source is a water faucet for water outlet.

### Embodiment 5

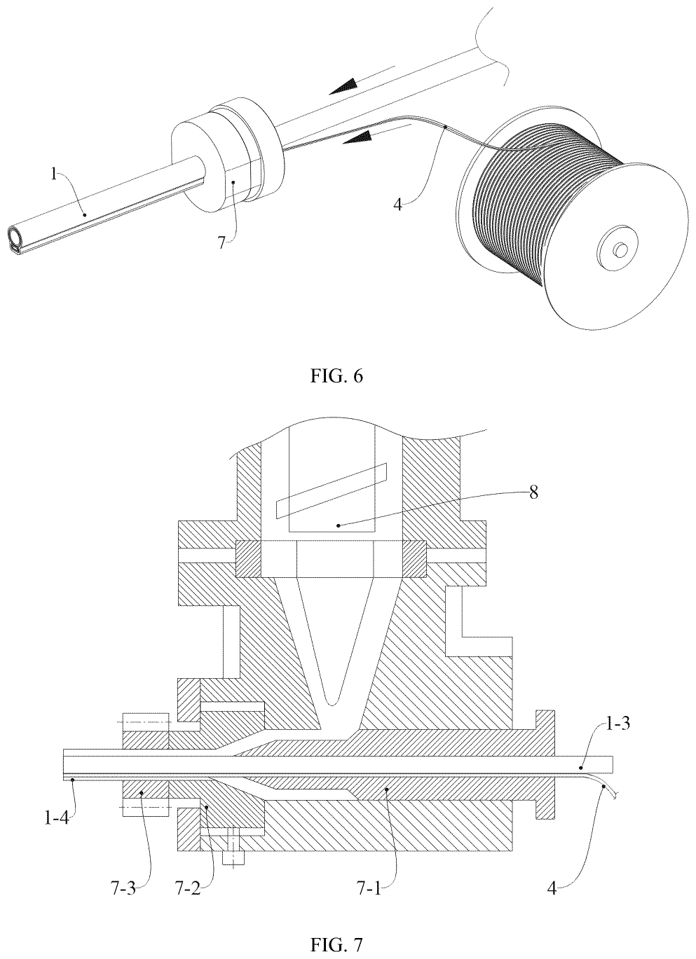

As shown in FIG. 6, a preparation process of a heating anti-freezing hose with a heat tracing band fixed by extrusion molding is used for preparing the heating hose body 1 in Embodiment 1, and comprises the following steps.

In step 1, four pipe-making stations are arranged in a water pipe extruder; and the four pipe-making stations are respectively used for machining the water-passing layer 1-1, the fiber mesh layer 1-2, the anti-explosion reinforced layer 1-3, and the heating and fixing layer 1-4. Molds of the first three pipe-making stations are conventional circular pipe forming molds, which belong to the prior art and will not be repeated herein. A special-shaped mold 7 is mounted in the fourth pipe-making station.

The special-shaped mold 7 comprises a guide pipe 7-1, a positioning mold 7-2 and a forming mold 7-3 which are coaxially and sequentially connected. A linear extrusion channel is arranged in the special-shaped mold 7. The extrusion channel is composed of a circular portion and a flat portion which are communicated together. The flat portion is arranged on one side of the circular portion. A feeding flow channel is arranged between the guide pipe 7-1 and the positioning mold 7-2 for feeding melted PVC. A shape of the extrusion channel is consistent with a cross-section shape of the heating hose body 1. An input port of the feeding flow channel is connected with an output port of a screw-type extruder 8. A shape of the extrusion channel at the positioning mold 7-2 makes the anti-explosion reinforced layer 1-3 contact with the heat tracing band 4.

In step 2, the first three pipe-making stations of the water pipe extruder are respectively used for coaxially machining the water-passing layer 1-1, the fiber mesh layer 1-2 and the anti-explosion reinforced layer 1-3 to form the inner water supply pipe.

In step 3, the inner water supply pipe machined in the step 2 penetrates through the circular portion of the extrusion channel of the special-shaped mold 7; the heat tracing band 4 penetrates through the flat portion of the extrusion channel of the special-shaped mold 7; and the fourth pipe-making station of the water pipe extruder forms the heating and fixing layer 1-4 on the outer side of the anti-explosion reinforced layer 1-3 and the heat tracing band 4 by extrusion molding. Therefore, fully automatic and continuous production of the heating anti-freezing hose with the heat tracing band fixed by extrusion molding is realized.

During solidification and cooling of the heating and fixing layer 1-4, an extrusion force is applied on the anti-explosion reinforced layer 1-3 and the heat tracing band 4 due to an inward shrinkage trend caused by thermal expansion and cold contraction, so that the anti-explosion reinforced layer 1-3 and the heat tracing band 4 are tightly attached together, thus increasing the contact area between the anti-explosion reinforced layer 1-3 and the heat tracing band 4. Since the extrusion force of the heating and fixing layer 1-4 on the heat tracing band 4 acts on all positions of the heat tracing band 4 uniformly, the heat tracing band 4 is not easily damaged.

Based on the above preparation method, all production procedures of the heating anti-freezing hose with the heat tracing band fixed by extrusion molding may be completed only by using the water pipe extruder in the embodiment, and a pipe material obtained by extrusion molding through the water pipe extruder has a flat surface, and can be directly used for sale. However, a surface of the heating hose spirally wound with the adhesive tape is uneven, and cannot meet a use requirement, so that the heating hose needs to be externally sheathed with a PVC water hose leather sleeve. A heat tracing band of an adhesion-type heating hose is directly exposed, so that the heating hose also needs to be sheathed with the PVC water hose leather sleeve. Moreover, both the spiral winding with the adhesive tape and the glue adhesion cannot be directly used in the water pipe extruder for producing a water pipe, so that productions of the heating hose spirally wound with the adhesive tape and the adhesion-type heating hose both need additional procedures, equipment and staffs except for the water pipe extruder, resulting in increased costs. Specific cost comparison of the three heating hoses above is shown in Table 3 below.

TABLE 5
Comparison table of production costs of different heating hoses

| | Heating anti-freezing hose with | | | Heating hose | | | | | |
|---|---|---|---|---|---|---|---|---|---|
| | heat tracing band fixed by | | | spirally wound | | | Adhesion-type | | |
| | extrusion molding provided by | | | with adhesive | | | heating | | |
| | the present invention (10 m) | | | tape (10 m) | | | hose (10 m) | | |
| Name of | | | Cost | | | Cost | | | Cost |
| material | Amount | | (Yuan) | Amount | | (Yuan) | Amount | | (Yuan) |
| PVC plastic for | 2,130 | g | 38.5 | 1,800 | g | 30.5 | 1,800 | g | 30.5 |
| water pipe | | | | | | | | | |
| Temperature limited | 10 | m | 50 | 10 | m | 50 | 10 | m | 50 |
| heating cable | | | | | | | | | |
| Glue for adhesion | 0 | | 0 | 0 | | 0 | 10 | g | 7.5 |
| Insulation | 0 | | 0 | 20 | m | 4.58 | 0 | | 0 |
| adhesive tape | | | | | | | | | |
| PVC water hose | 0 | | 0 | 10 | m | 25 | 10 | m | 25 |
| leather sleeve | | | | | | | | | |
| Labor | 1 | staff | 8 | 4 | staffs | 32 | 3 | staffs | 24 |
| Total | | | 96.5 | | | 142.08 | | | 137 |

It can be seen from Table 5 that the heating anti-freezing hose with the heat tracing band fixed by extrusion molding provided by the present invention is used stably at −40° C., and has a production cost significantly reduced compared with existing heating hoses at the same time. Moreover, the costs counted in Table 5 exclude additional equipment cost, management cost and space use cost required for producing the heating hose spirally wound with the adhesive tape and the adhesion-type heating hose.

1. A heating anti-freezing hose with a heat tracing band fixed by extrusion molding, comprising a heating hose body (1); the heating hose body (1) comprising the heat tracing band (4) and an inner water supply pipe; and one side of the heat tracing band (4) being attached to an outer side of an anti-explosion reinforced layer (1-3), wherein the heating anti-freezing hose further comprises a heating and fixing layer (1-4); and the heating and fixing layer (1-4) is wrapped on an outer side of the heat tracing band (4) and the anti-explosion reinforced layer (1-3) by pipe fitting extrusion molding.

2. The heating anti-freezing hose with the heat tracing band fixed by extrusion molding according to claim 1, wherein the inner water supply pipe comprises a water-passing layer (1-1), a fiber mesh layer (1-2) and the anti-explosion reinforced layer (1-3) which are sequentially laminated from inside to outside.

3. The heating anti-freezing hose with the heat tracing band fixed by extrusion molding according to claim 2, wherein the anti-explosion reinforced layer (1-3) and the heating and fixing layer (1-4) are made of the same material and integrated into a whole after extrusion molding.

4. The heating anti-freezing hose with the heat tracing band fixed by extrusion molding according to claim 1, wherein the heat tracing band (4) comprises an electric core (4-1), and a sleeve layer (4-2), a shielding mesh (4-3), an insulating layer (4-4) and a conductive heating core (4-5) which are sequentially wrapped from outside to inside; and two electric cores (4-1) arranged at an interval are both buried inside the conductive heating core (4-5).

5. The heating anti-freezing hose with the heat tracing band fixed by extrusion molding according to claim 1, wherein two ends of the heating hose body (1) are both provided with a hose connector (3); and a joint between the hose connector (3) and the heating hose body (1) is wrapped with a connector sleeve (2).

6. The heating anti-freezing hose with the heat tracing band fixed by extrusion molding according to claim 1, wherein one end of the heat tracing band (4) extends out of a corresponding end of the heating hose body (1), or two ends of the heat tracing band (4) both extend out of two ends of the heating hose body (1); and a part of the heat tracing band (4) extending out of the heating hose body (1) is wound on a water supply connector of a water source or a water receiving end in use.

7. The heating anti-freezing hose with the heat tracing band fixed by extrusion molding according to claim 6, further comprising a heat insulation sleeve (8), wherein the heat insulation sleeve is capable of wrapping the water supply connector of the water source or the water receiving end; the water supply connector of the water source and/or the water receiving end wound with the heat tracing band (4) is wrapped by the heat insulation sleeve (8) in use; and a length of an end portion of the heat tracing band (4) extending out of an end portion of the heating hose body (1) is 20 cm to 50 cm.

8. The heating anti-freezing hose with the heat tracing band fixed by extrusion molding according to claim 1, further comprising a temperature control switch (5) and a power supply plug (6), wherein one end of a power supply interface of the heat tracing band (4) is connected with the power supply plug (6) through the temperature control switch (5); the temperature control switch (5) is used for controlling powering on and off of the heat tracing band (4) according to an environment temperature; and when the temperature is lower than a threshold, the temperature control switch (5) is turned on.

9. The heating anti-freezing hose with the heat tracing band fixed by extrusion molding according to claim 8, wherein the temperature control switch (5) comprises a shell (5-1), a wiring terminal (5-2), a hot bimetallic strip (5-4), an actuating rod (5-5), a first contact piece (5-7) and a second contact piece (5-8); the first contact piece (5-7) is mounted in a central position in the shell (5-1); the actuating rod (5-5) is slidably connected in the shell (5-1); the hot bimetallic strip (5-4) is mounted in the shell (5-1); the hot bimetallic strip (5-4), the actuating rod (5-5) and the first contact piece (5-7) are sequentially arranged along a sliding direction of the actuating rod (5-5); an end portion of the actuating rod (5-5) oriented to the first contact piece (5-7) is fixed with the second contact piece (5-8); edges of two ends of the hot bimetallic strip (5-4) are clamped between an end cover (5-3) and a limiting block inside the shell (5-1); a spring is mounted between the actuating rod (5-5) and the shell (5-1); the spring applies an elastic force to the actuating rod (5-5) towards the hot bimetallic strip (5-4); two wiring terminals (5-2) are fixed on the shell (5-1); the first contact piece (5-7) is electrically connected with one wiring terminal (5-2); the second contact piece (5-8) is electrically connected with the other wiring terminal (5-2); when the temperature is greater than or equal to the threshold, the hot bimetallic strip (5-4) protrudes towards one side far away from the first contact piece (5-7), and the second contact piece (5-8) is separated from the first contact piece (5-7); and when the temperature is less than the threshold, the hot bimetallic strip (5-4) protrudes towards one side close to the first contact piece (5-7), and the second contact piece (5-8) is contacted with the first contact piece (5-7).

10. The heating anti-freezing hose with the heat tracing band fixed by extrusion molding according to claim 1, wherein a preparation process comprises the following steps of:
step 1: producing the inner water supply pipe by a water pipe extruder; and
step 2: combining the inner water supply pipe with the heat tracing band (4) by the water pipe extruder provided with a special-shaped mold, wherein an extrusion channel of the special-shaped mold (7) comprises a circular portion and a flat portion which are communicated together; and the flat portion is arranged on one side of the circular portion; penetrating the inner water supply pipe produced in the step 1 through the circular portion of the extrusion channel of the special-shaped mold (7); penetrating the heat tracing band (4) through the flat portion of the extrusion channel of the special-shaped mold (7); and melting raw material particles by the water pipe extruder and then transporting the raw material particles into the extrusion channel of the special-shaped mold (7), and solidifying the raw material particles in the extrusion channel to form the heating and fixing layer (1-4).

11. The heating anti-freezing hose with the heat tracing band fixed by extrusion molding according to claim 2, wherein one end of the heat tracing band (4) extends out of a corresponding end of the heating hose body (1), or two ends of the heat tracing band (4) both extend out of two ends of the heating hose body (1); and a part of the heat tracing band (4) extending out of the heating hose body (1) is wound on a water supply connector of a water source or a water receiving end in use. 12. The heating anti-freezing hose with the heat tracing band fixed by extrusion molding according to claim 3, wherein one end of the heat tracing band (4) extends out of a corresponding end of the heating hose body (1), or two ends of the heat tracing band (4) both extend out of two ends of the heating hose body (1); and a part of the heat tracing band (4) extending out of the heating hose body (1) is wound on a water supply connector of a water source or a water receiving end in use.

12. The heating anti-freezing hose with the heat tracing band fixed by extrusion molding according to claim 4, wherein one end of the heat tracing band (4) extends out of a corresponding end of the heating hose body (1), or two ends of the heat tracing band (4) both extend out of two ends of the heating hose body (1); and a part of the heat tracing band (4) extending out of the heating hose body (1) is wound on a water supply connector of a water source or a water receiving end in use.

13. The heating anti-freezing hose with the heat tracing band fixed by extrusion molding according to claim 5, wherein one end of the heat tracing band (4) extends out of a corresponding end of the heating hose body (1), or two ends of the heat tracing band (4) both extend out of two ends of the heating hose body (1); and a part of the heat tracing band (4) extending out of the heating hose body (1) is wound on a water supply connector of a water source or a water receiving end in use.

14. The heating anti-freezing hose with the heat tracing band fixed by extrusion molding according to claim 2, further comprising a temperature control switch (5) and a power supply plug (6), wherein one end of a power supply interface of the heat tracing band (4) is connected with the power supply plug (6) through the temperature control switch (5); the temperature control switch (5) is used for controlling powering on and off of the heat tracing band (4) according to an environment temperature; and when the temperature is lower than a threshold, the temperature control switch (5) is turned on.

15. The heating anti-freezing hose with the heat tracing band fixed by extrusion molding according to claim 3, further comprising a temperature control switch (5) and a power supply plug (6), wherein one end of a power supply interface of the heat tracing band (4) is connected with the power supply plug (6) through the temperature control switch (5); the temperature control switch (5) is used for controlling powering on and off of the heat tracing band (4) according to an environment temperature; and when the temperature is lower than a threshold, the temperature control switch (5) is turned on.

16. The heating anti-freezing hose with the heat tracing band fixed by extrusion molding according to claim 4, further comprising a temperature control switch (5) and a power supply plug (6), wherein one end of a power supply interface of the heat tracing band (4) is connected with the power supply plug (6) through the temperature control switch (5); the temperature control switch (5) is used for controlling powering on and off of the heat tracing band (4) according to an environment temperature; and when the temperature is lower than a threshold, the temperature control switch (5) is turned on.

17. The heating anti-freezing hose with the heat tracing band fixed by extrusion molding according to claim 5, further comprising a temperature control switch (5) and a power supply plug (6), wherein one end of a power supply interface of the heat tracing band (4) is connected with the power supply plug (6) through the temperature control switch (5); the temperature control switch (5) is used for controlling powering on and off of the heat tracing band (4) according to an environment temperature; and when the temperature is lower than a threshold, the temperature control switch (5) is turned on.
